(19) United States
(12) Patent Application Publication
(10) Pub. No.: US 2002/0148658 A1
(43) Pub. Date: Oct. 17, 2002

(54) Power driving device of cart

(76) Inventor: Shu-Hsien Li, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/833,692

(22) Filed: Apr. 13, 2001

(51) Int. Cl. B60K 6/00

(52) U.S. Cl. 180/65.2; 180/65.1

(57) ABSTRACT

A power driving device is incorporated in a cart for assisting in moving the cart. The power driving device includes a motor mechanically coupled to at least a wheel of the cart for driving the wheel. A torque detector is mounted in the cart to detect a torque resulting from a force applied by a user to move the cart and to generate an electrical signal corresponding to the torque detected. The signal is applied to a controller that is electrically connected to the motor. The controller controls the operation of the motor based on the signal received thereby ensuring a proper operation of the motor. A power supply is electrically connected to the controller for powering the power driving device and the motor. The controller controls the power supplied to the motor and thus protects the power supply from over-discharge.

### FIELD OF THE INVENTION

The present invention generally relates to a power driving device of a cart and in particularly to an automatically regulated power driving device of a cart which is operated based on a feedback signal.

### BACKGROUND OF THE INVENTION

A cart driven by human labor is commonly employed in transporting articles in short distances or helping disabled people to move. Examples are agriculture carts, construction carts, wheelchairs and strollers. All these carts or wheelchairs are in general driven by human labor. Difficult in operation may occur when driving heavy articles or moving uphill.

Carts with power assisting device are also known. Such carts are provided with a motor which is controlled by simply turning on and off. Thus, the output of the motor is in general not regulated and thus cannot be well controlled by a user to suit the actual requirement the user needs. Damage of property or human body may be caused due to such a poor controlled motorized cart. In addition, since the motor is not properly controlled, over-discharge of a battery set supplying power to the motor may occur which shortens the service life of the battery set and thus increasing maintenance costs.

Thus, it is desired to have a power driving device of a cart, which can be well controlled to avoid the above problems.

### SUMMARY OF THE INVENTION

Accordingly, an object of the present invention is to provide a power driving device of a cart, which assists in moving the cart.

Another object of the present invention is to provide a power driving device of a cart comprising a motor controlled by a controlling device based on a torque feed back signal whereby a proper control of the motor can be achieved.

A further object of the present invention is to provide a power driving device of a cart which is automatically regulated and controlled based on a torque feed back signal so as to ensure safety of operation of the cart.

To achieve the above objects, in accordance with the present invention, a power driving device of a cart comprises a motor mechanically coupled to at least a wheel of the cart for assisting in moving the cart. A torque detector is mounted in the cart to detect a torque resulting from a force applied by a user to move the cart and to generate an electrical signal corresponding to the torque detected. The signal is applied to a controller that is electrically connected to the motor. The controller controls the operation of the motor based on the signal received thereby ensuring a proper operation of the motor. A power supply is electrically connected to the controller for powering the power driving device and the motor. The controller controls the power supplied to the motor and thus protects the power supply from over-discharge.

### BRIEF DESCRIPTION OF THE DRAWINGS

The present invention will be apparent to those skilled in the art by reading the following description of preferred embodiments with reference to the attached drawings, in which:

FIG. 1 is an elevational view of a cart incorporating a power driving device in accordance with the present invention;

FIG. 2 is a system block diagram of the power driving device of the present invention;

FIG. 3 is perspective view showing an example of a torque detector employed in the power driving device of the present invention;

FIG. 4 is a cross-sectional view of the cart showing the torque detector and a controller of the power driving device in accordance with the present invention mounted in the cart;

FIG. 5 is an enlarged view of encircled portion A of FIG. 4;

FIG. 6 is a top view, partially sectioned, of a modification of the cart shown in FIG. 1;

FIG. 7 is a side elevational view of another embodiment of the present invention in which the power driving device of the present invention is incorporated in a wheelchair; and

FIG. 8 is a side elevational view of a farther embodiment of the present invention in which the power driving device of the present invention is incorporated in a stroller.

### DETAILED DESCRIPTION OF THE PREFERRED EMBODIMENTS

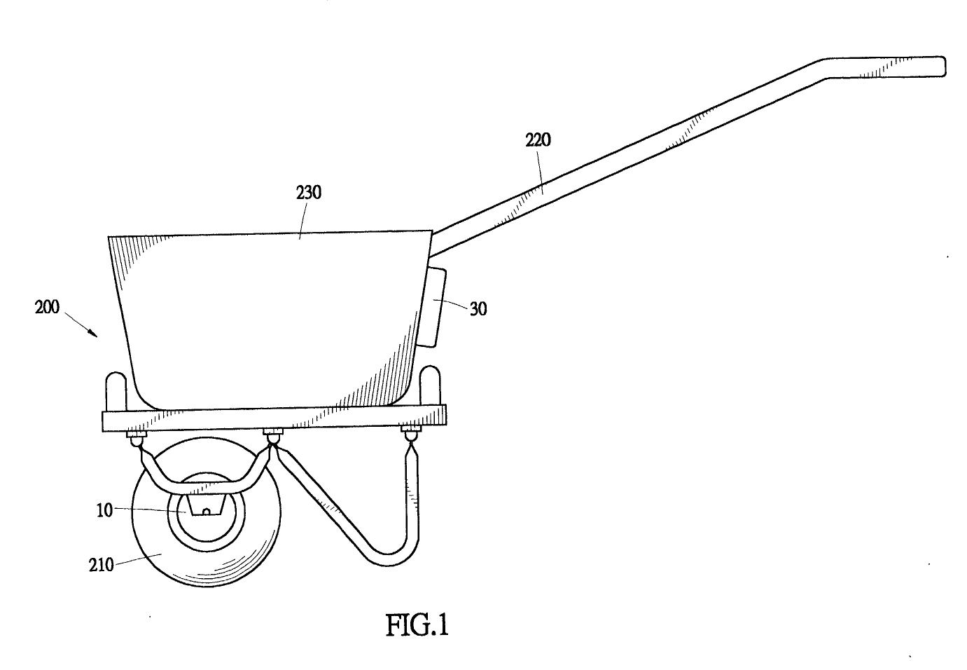

With reference to the drawings and in particular to FIG. 1, wherein a cart generally designated with reference numeral 200 is shown, the cart 200 comprises a tray 230 to which a wheel 210 is mounted for supporting the cart 200 on for example the ground. At least one handle 220 is attached to and extending from the tray 230 for user's handling the cart 200.

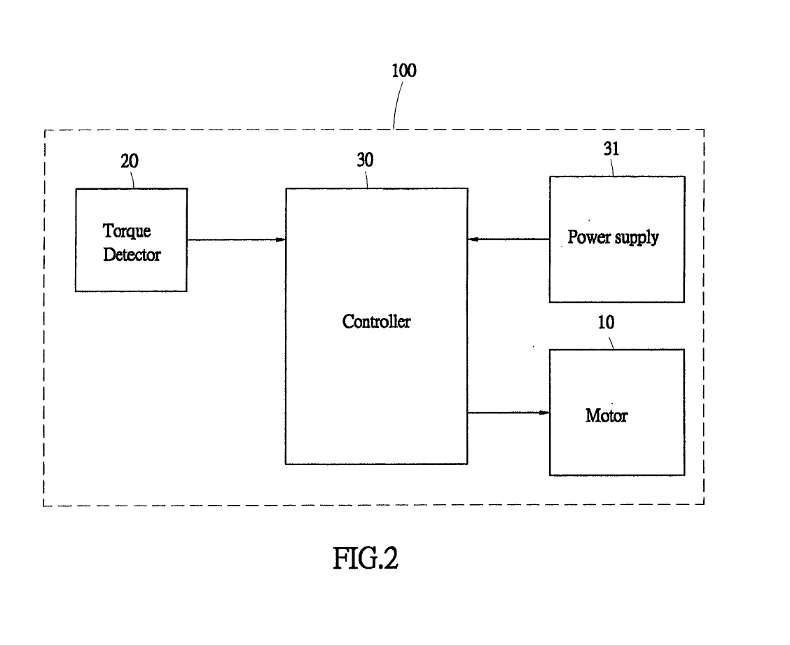

Also referring to FIGS. 2-4, in accordance with the present invention, a power driving device, generally designated with reference numeral 100, is incorporated in the cart 200 for assisting in the user's handling/moving the cart 200. The power driving device 100 of the present invention comprises a motor 10 mechanically coupled to the wheel 210 for driving the cart 200. In the embodiment illustrated, the motor 10 is a rim motor fitting in the wheel 210. However, the motor 10 may be any suitable rotary device, such as an alternate current (AC) driven motor or a direct current (DC) driven motor. The motor 10 may be operated to drive the wheel 210 in both forward and rearward directions. Examples of the motor 10 may be found in U.S. Pat. No. 5,749,429 and Taiwan Patent Publication No. 207219. Since the motor is well known to those having ordinary skills in the art and since the motor constitutes no novel part of the invention, a detailed description of the motor is not necessary and thus will be omitted herein.

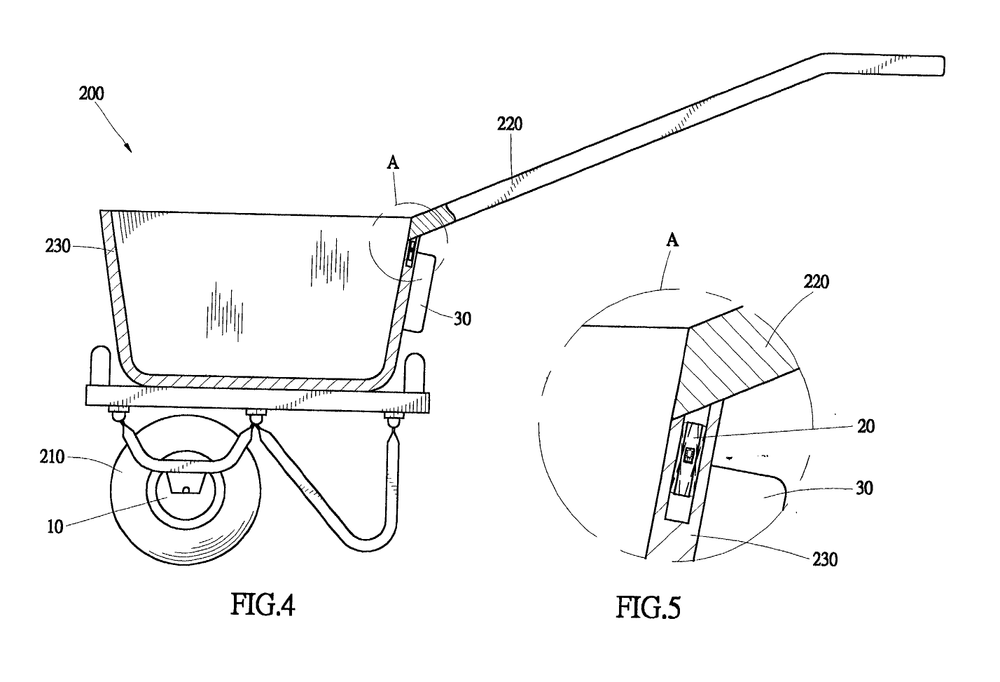

The power driving device 100 of the present invention comprises a torque detector 20 and a controller 30. The torque detector 20 may be installed in any suitable position on the cart 200 to detect a torque that the user applies to the cart 200 during moving the cart 200. In the embodiment illustrated in FIG. 1, the torque detector 20 is mounted in a wall of the tray 230 at a location proximate to and beneath the connection between the handle 220 and the tray 230 as shown in FIGS. 4 and 5. A cavity (not labeled) may be formed to accommodate the torque detector 20. However, the torque detector 20 may be simply attached to the wall of the tray 230 or other places of the cart 200.

When the user pushes/pulls the cart 200, a torque is generated at the connection between the handle 220 and the tray 230. The torque is detected by the torque detector 20. The torque caused by the user forcing the cart 200 forward/rearward varies with the force that the user applies to the handle 220. Thus, for example, when the cart 200 is moved uphill, the torque generated is greater than that needed when the cart 200 is moving on a horizontal surface.

The controller 30 is mounted to a wall of the tray 230, preferably outside the tray 230 as shown in FIG. 4. If desired, the controller 30 may be mounted at other positions of the cart 200, such as the handle 220. The torque detector 20, when detecting a torque, generates an electrical signal that is then fed back to the controller 30. The controller 30 controls the operation of the motor 10 based on the electrical signal received from the torque detector 20.

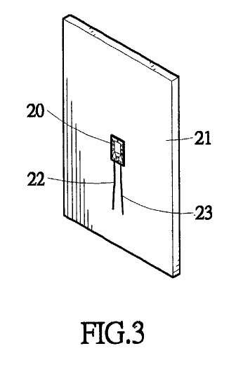

The torque detector 20 may assume any suitable form and may be embodied with any known means. An example of the torque detector 20 comprises a device having an electrical resistance variable with the torque applied thereto. A bi-metal element, such as copper and nickel alloys, is an example of such a device. A market available bi-metal torque detecting element is those marketed with model number KFG series made by Japanese companies as shown in FIG. 3. The torque detecting element comprises a flat body attached to a metal plate 21. Such a metal plate 21 can be attached to the wall of the tray 230 directly. The torque detecting element has a pair of terminals 22, 23 connected to the controller 30.

A power supply 31, such as a battery set, is mounted to the cart 200 and electrically coupled to the controller 30 for powering the controller 30 and the motor 10.

The controller 30 may be any known device that is capable to control a motor based on signals received. Such a device is well known to those having ordinary skills in the art and thus no further detail will be given.

Thus, it is clearly understood that in accordance with the present invention, a motor is mechanically coupled to a wheel for driving the cart and that the operation of the motor is controlled by a controller which is in turn operated based on signals corresponding to force applied to the cart by a user whereby when the user applies a large force to the cart, a great output is generated by the motor by being controlled by the controller, while a small output is generated by the motor when the user applies a small force to the cart. This facilitates the control and regulation of the power assisting device of the cart by a user.

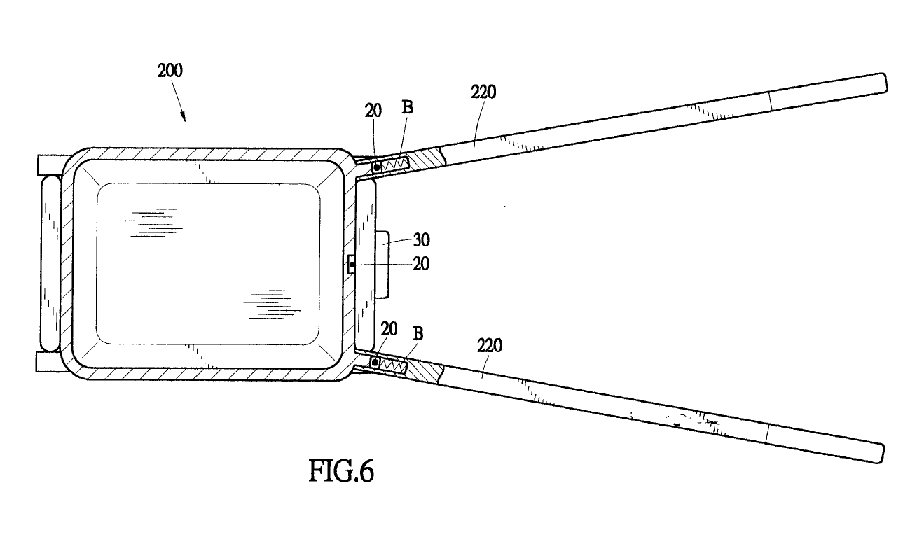

FIG. 6 shows a modification of the embodiment illustrated in FIGS. 1-5. In the modified embodiment of FIG. 6, a cart 200 having two handles 220 is shown. A torque detector 20 is mounted to the tray 230 at a location midway between the handles 220. This allows a more precise detection of the torque applied to the tray 230. In addition, a pair of torque detectors 20 is respectively embedded in the handles 220 proximate to the tray 230 of the cart 200. The torque detectors 20 embedded in the handles 220 are supported by springs B. A more precise control of the motor 10 through signals from all the torque detectors 20 can thus be achieved.

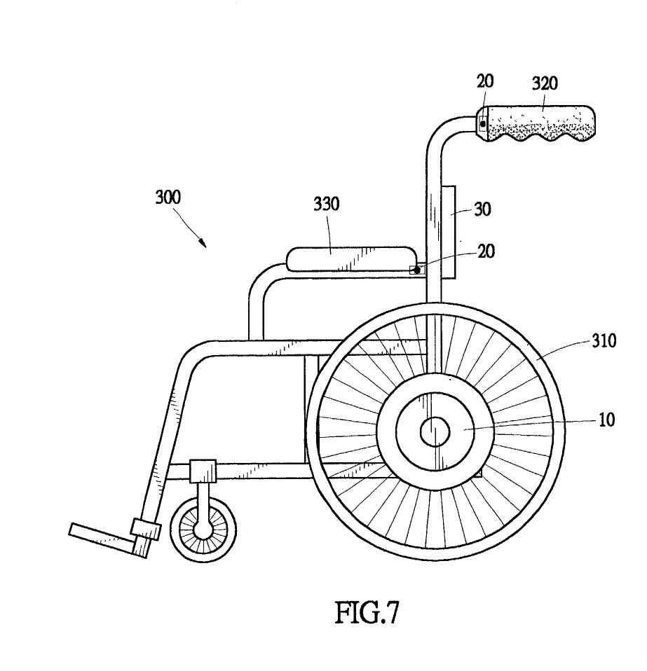

Another embodiment of the present invention is shown in FIG. 7 wherein a wheelchair 300 incorporating the power driving device of the present invention is shown. A motor 10 is mounted in at least one wheel 310 of the wheelchair 300. A torque detector 20 is mounted in handles 320 of the wheelchair 300 and is coupled to a controller 30. The controller 30 receives signals from the detector 20 and controls the operation of the motor 10 based on the signal received. Alternatively or additionally, a torque detector 20 is mounted in an armrest 330 of the wheelchair 300 for detecting the torque applied thereto.

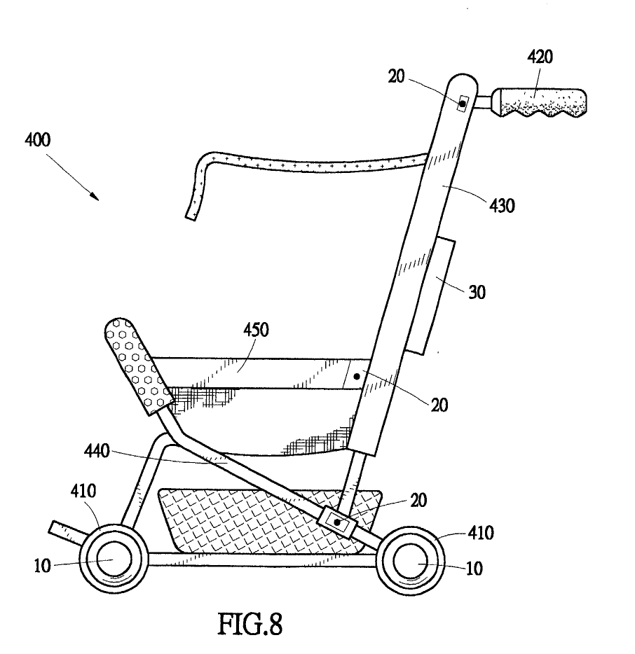

FIG. 8 shows a further embodiment of the present invention wherein a stroller 400 incorporating the power driving device of the present invention is illustrated. The stroller 400 comprises a plurality of wheels 410 in at least one of which a motor 10 is mounted. A torque detector 20 is mounted to a frame 430 of the stroller 400 proximate to the handles 420 for detecting torque applied thereto. An electrical signal is generated by the torque detector 20 and is applied to a controller 30 mounted to a frame of the stroller 400 that in turn controls the operation of the motor 10 based on the signal received. Alternatively or additionally, a torque detector 20 is mounted in any bar(s) 440 and/or 450 of the frame of the stroller 400 to alternatively or additionally provide electrical signal(s) to the controller 30 for more precise control and regulation of the operation of the motor 10.

Based on the previous description, the following advantages can be recognized:

(1) A power driving device is incorporated in a traditional human labor driving cart or the likes. This allows a user to more easily control and move the cart. A more efficient and more effective operation of the cart is achieved.

(2) The operation of the motor is based on the feed back signals from the torque detector whereby the output of the motor is automatically regulated and thus a proper operation of the motor can be obtained which ensures safety of operating the cart.

(3) Electrical power supplied to the motor is controlled by the controller whereby a battery set serving as the power supply may not be over-discharged. The service life of the battery set can thus be extended.

Although the present invention has been described with reference to the preferred embodiments thereof, it is apparent to those skilled in the art that a variety of modifications and changes may be made without departing from the scope of the present invention which is intended to be defined by the appended claims.

What is claimed is

1. A power driving device of a cart comprising:
a motor adapted to be mechanically coupled to a wheel of a cart for driving the cart;
a torque detector adapted to be mounted to the cart at a position to detect a torque resulting from a force applied to the cart by a user in manually moving the cart, the torque detector generating an electrical signal based on the torque detected; and
a controller electrically coupled to the torque and the motor, the controller controlling the motor based on the electrical signal received from the torque detector.

2. The power driving device as claimed in claim 1, wherein the motor is an alternate current driven motor.

3. The power driving device as claimed in claim 1, wherein the motor is a direct current driven motor.

4. The power driving device as claimed in claim 1, wherein the torque detector comprises a bi-metal element.

5. The power driving device as claimed in claim 1, wherein the torque detector comprises a device having an electrical resistance variable with torque applied thereto.

6. The power driving device as claimed in claim 1, wherein the torque detector comprises a pair of terminals connected to the controller.

7. The power driving device as claimed in claim 1, wherein the torque detector is attached to a metal plate that is mounted to the cart.

8. The power driving device as claimed in claim 1 further comprising a power supply device electrically connected to the controller for powering the power driving device and the motor.
